(19) United States
(12) Patent Application Publication
(10) Pub. No.: US 2015/0152748 A1
(43) Pub. Date: Jun. 4, 2015

(54) RC-BASED VAPOR TRAPS CASCADE

(71) Applicant: Mark Labinov, Glastonbury, CT (US)

(72) Inventor: Mark Labinov, Glastonbury, CT (US)

(21) Appl. No.: 14/096,579

(22) Filed: Dec. 4, 2013

(51) Int. Cl. F01K 17/04; F16T 1/38

(52) U.S. Cl. CPC F01K 17/04; F16T 1/38

(57) ABSTRACT

A method for tuning a system of cascade oscillating vapor traps to utilize the high-pressure condensate and produce intermittent power output on the basis of the physicochemical line of Retrograde Condensation in the two-phase zone. The method is based on usage of the “natural” frequencies, defined by the fluid on every point on said line and is radically different from the way steam traps are tuned presently.

### CROSS-REFERENCE TO RELATED APPLICATIONS

Applicant claims the benefit of provisional patent application Ser. No. 61/733,741, filed Dec. 5, 2012 by the present inventor which application is incorporated herein in its entirety.

### TECHNICAL FIELD

The invention has particular application to methods and apparatus for removing condensate, air, and non-condensable gas from steam space while preventing the loss of steam and energy derived from steam. Steam space is the flow of steam, and the general area of usage for traditional steam traps. In particular, this application relates to an improved steam trap apparatus and method.

The present invention is generally directed to steam traps. More particularly, the present invention is directed to a method for tuning a system of cascade oscillating vapor traps to utilize the high pressure condensate discharge of a steam pipe system. Even more particularly, the present invention is directed to producing intermittent power output based on the physicochemical line of retrograde condensation in the two-phase zone. The cascade can be assembled for any pure vapor-liquid substance, not specifically for water, for which vapor is designated as “steam” in engineering practice. The definition “vapor traps cascade” is more appropriate to account for the possibility of different liquid substances other than water.

### BACKGROUND OF THE INVENTION

The prior art includes traditional steam traps that are used to separate condensate from the steam. Three important functions of steam traps are to (1) discharge condensate as soon as it is formed (2) have a negligible steam consumption, and (3) have the capability of discharging air and other non-condensable gases. Steam trap apparatuses are necessary elements of any steam system because they allow steam to reach its destination in as dry a state as possible to perform its task efficiently and economically. Steam trap apparatuses release condensate, air, and non-condensable gas from a steam space while preventing loss of steam.

Condensate traps are commonly used in steam systems, in which circumstances they are usually referred to as steam traps. Their function is to discharge condensed water from the system without allowing steam to escape. The loss of steam from a system represents a waste of energy. The conventional steam trap apparatus is comprised of two actuated valves, piping, and a steam trap which is typically an automatic valve not connected to a control system.

Steam traps thus commonly comprise a valve which is responsive to the presence of condensate or steam in the vicinity of the valve, so that the valve opens when condensate is present and closes when steam is present.

This invention relies on the retrograde condensation phenomenon and the perspective of its utilization in sustainable energy systems. The phenomenon defines a thermodynamic line in the two-phase zone, the utilization of which could alter the principles of the thermodynamic machines' design by including the physicochemical properties of the substance as a driving force. Modern power storage and extracting technologies are based on equilibrium thermodynamic processes, not on the physicochemical nature of the working substances subjected to those processes.

Retrograde condensation manifests itself in a pure fluid as a reverse behavior of the vapor quality at a constant specific volume to the left of the critical value—essentially the vapor is reverted back to condensate regardless of whether heating or cooling occurs. For every specific volume there is only one unique point where the rate of the quality variation with temperature dx/dT changes its sign from positive to negative.

The formula for the locus connecting those points defines the retrograde condensation line. Around each point on this line a limit cycle of evaporation/condensation takes place with the frequency of oscillations depending solely on the properties of the substance.

These oscillations lead to the associated pressure waves with significant amplitudes depending on the location of the point on the locus.

Sustainable energy requires an environment-based approach such as targeting fluids as operational environments with certain optimal points or loci coveting to specific ways of power extraction or transmission.

Published U.S. patent application Ser. No. 2011/0084222 describes a valve element for a condensate trap comprising an expansion chamber in the form of a metallic bellows having a variable axial length and has first and second ends sealed with caps. Although a valve element for a steam trap is necessary in the proposed method, the valve described in the reference is neither programmable nor programmed in accordance with an optimal algorithm to provide power from discharged condensate.

U.S. Pat. No. 7,578,967 is directed to an apparatus and a system that reduces water wasting, but does not exploit the power generation potential of the collapsing steam, or utilize the retrograde condensation (RC) line to control a needle valve.

This novel method is distinguishable from U.S. patent application Ser. No. 2010/0294377. That application dealt with an apparatus and method for removing condensate and unwanted gas from vapor/liquid systems while preventing steam loss and real-time data collection. The prior application also does not deal with the power storage and generation aspects of the claimed method.

From the above, it is therefore seen that there exists a need in the art to overcome the deficiencies and limitations described herein and above.

### SUMMARY OF THE INVENTION

The shortcomings of the prior art are overcome and additional advantages are provided through the process being based on the usage of the “natural” frequencies, defined by the fluid on every point on the Retrograde Condensation line (RC line), which is radically different from the way that steam traps are tuned presently. By aligning the steam traps to the limit cycle frequencies, intermittent, transient power generation can occur without permanent external heating.

In another aspect, this thermodynamic automatic vapor trap arrangement method does not involve flash steam. The RC-line, when used, leads to the direct transfer of energy.

Accordingly, it is an object of the present invention to create an environment-based approach to generate power without further permanent external heating.

It is another object of the present invention to prevent the loss of power through discharge of condensate.

It is yet another object of the present invention to have the control system based on the RC-line. The signal from the piping is processed through the RC-line so that the proper trap-energy generator can be identified.

It is a still further object of the present invention to have every trap tuned to the specific location on the RC-line. The tuning of the trap can be achieved by adjustment of the initial location of the piston with providing for the maximum piston swept volume.

It is still another object of the present invention that when the trap exhausts its power potential the residual condensate is drained through a drainage valve and the cycle can be repeated.

Lastly, but not limited hereto, it is an even further object of the present invention to generate and store power without permanent external heating.

Unlike the traditional steam traps, which are primarily discarding units, the main goal of the power cascade is to deliver intermittent power upon request. The power cascade method could be used for an emergency, priming, or just replenishment of storage. The primary novelty is the existence of the RC-line defined by a single formula and the existence of the uniquely defined vapor quality and pressure oscillations in limit cycles around the points on that line. The frequencies of those oscillations depend on the fluid parameters and RC-locations.

If the RC-line is not followed, the oscillating cascade cannot be accomplished and no power will result.

Additional features and advantages are realized through the techniques of the present invention. Other embodiments and aspects of the invention are described in detail herein and are considered a part of the claimed invention.

A method for generating power from high pressure condensate either coming from the fluid flow or expelled from a vapor trap apparatus, comprising: providing a system of pipes either conducting the fluid flow or conducting two-phase flow, equipped with conventional vapor traps that extract and collect the high pressure condensate; providing residual pressure sensors measuring pressure levels in the pipes conducting fluid flows or in condensate lines; providing temperature sensors measuring temperature levels in the pipes conducting fluid flows or in the condensate lines; providing a group of power vapor traps with a needle expansion valve and moving pistons delivering power directly by condensate flash evaporation into the trap with subsequent pressure oscillations; providing a data processing unit capable of tracking pressure and temperature data values, wherein data processing unit processes the data, lines up the parameters of piston position, pressure, temperature, and designates a trap volume to use; providing a data processing unit capable of issuing signals through the control signal system to a needle expansion valve and a heat tracing element; receiving the signal from the data processing unit through the control signal system and heating the designated trap volume to a saturation temperature (Ts) corresponding to a defined point on the RC-line through a heat tracing element; turning off the heat tracing element after the desired saturation temperature; draining all power generation volumes of the condensate, pistons are in the lower start positions, residual pressure sensors deliver the data to the data processing unit; and delivering pressure and temperature data provided by sensors on the high pressure pipes to the data processing unit.

Upon receiving the signal from the data processing system through the control signal system providing a servomotor on an expansion needle valve and opening the expansion needle valve allowing flow to designated volume until the pressure and temperature feedback signals from it reach the desired RC-point. Where the needle valve closes and the piston is released at the same moment, initiating the oscillations. Including the step of tuning respective vapor traps to an RC-line at different frequencies and amplitudes to create an oscillating cascade. Further including the tuning the trap by adjustment of the initial location of the piston. Further including utilizing the power extracted for auxiliary energy storage and recharging.

After the vapor trap exhausts its power potential, further includes the step of draining the residual condensate through a drainage valve and then repeating the cycle.

One or more non-transitory computer readable storage media having program code stored thereon that when processed by one or more processors causes a method to be performed, the method comprising: performing an initialization step during which information is obtained from every high pressure pipe involved in the cascade; storing information in a first memory location of a processor; utilizing the RC-line to calculate, based on the stored information, optimum temperature, pressure levels, and power-generation trap volume; heating the power-generation trap volume to a saturation level corresponding to the defined point of the RC-line; and tuning respective vapor traps to an RC-line at different frequencies and amplitudes to create an oscillating cascade.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a pictorial representation of prior art where water is heated to generate steam, the residual condensate is removed from the system and is returned to the source to be re-heated and again generate steam.

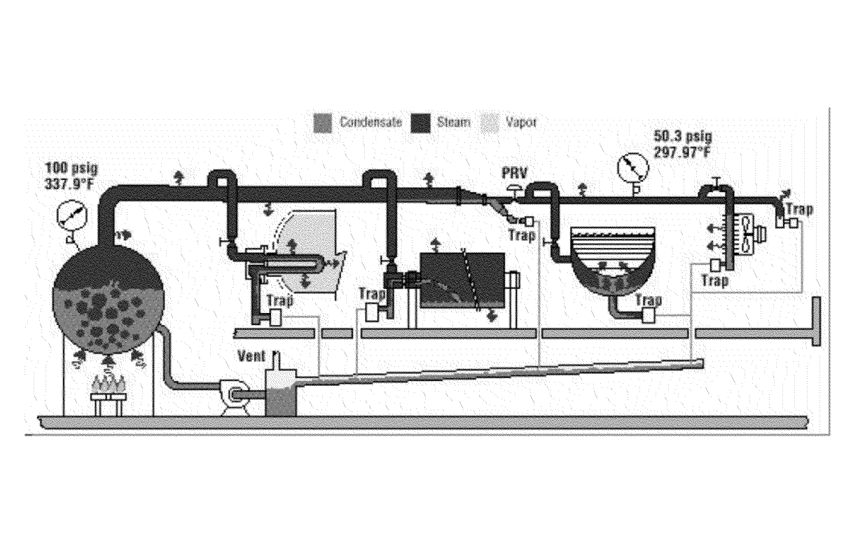

FIG. 2 is a graphical representation of the physicochemical line of Retrograde Condensation in the two-phase zone.

FIG. 3 shows the RC-line for water (recreated from ASME Water Tables) ASME Steam Tables, 6th Edition, ASME, NY, 1993.

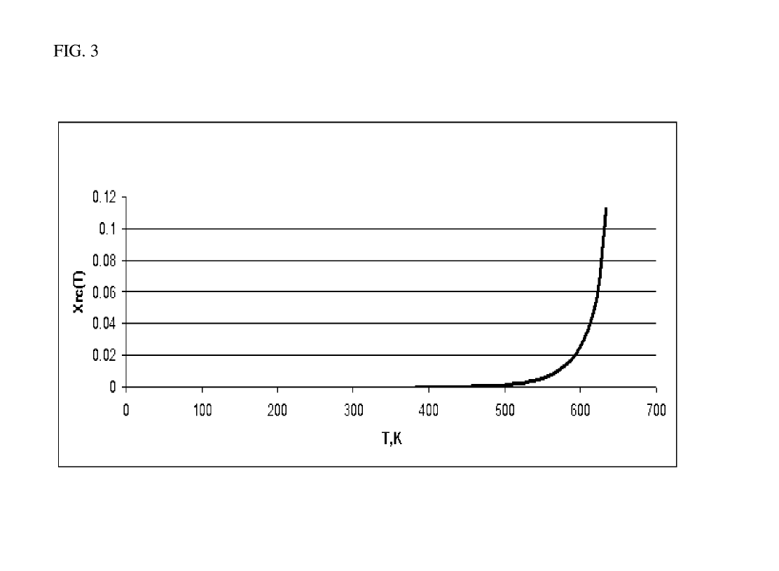

FIG. 4 shows the cascade control system.

### DETAILED DESCRIPTION

The cascade power generation arrangement:

Every high pressure pipe involved in the cascade (1, 2, or 3) is equipped with the sensor/data transmitter to deliver the data to the data processing unit 8. The data processing unit contains the Ps- v- Ts- hs-saturated line data for the fluid in question (this comes from the published tables for the pure fluids, like ASME tables for water or NIST tables for a line of pure fluids): Ps-saturated pressure, Ts-saturation temperature, v- either liquid v₁ or vapor vᵥₚ specific volume on the saturation line, hs-specific enthalpies hs₁ and hsᵥₚ- of liquid and vapor branches respectively. The data processing unit is programmed with the tabulated RC-line formula for vapor quality vs. temperature, for the fluid in question:

$${x}_{RC} = \frac{d {v}_{l} / d T}{[ d {v}_{l} / d T - d {v}_{vp} / d T ]} \qquad ( 1 )$$

v₁-specific liquid volume on the saturation line, m̂3/kg

vᵥₚ-specific vapor volume on the saturation line, m̂3/kg

T-temperature, K

The method is used to tune the max swept volumes in the volumetric power generation traps 5, connected to mechanical/electrical power generation or power storage devices (in an embodiment, flywheels). Those connections could be performed through any linear transmission mechanism, like a Rhombic Drive.

The tabulated RC-line, contains the tabulated values for RC related oscillation frequencies (per sample formula 2 presented for the region close to the critical point). Associated relative pressure amplitudes ΔPₘₐₓ/Ps and relative max swept volumes Vₘₐₓ/V₀ are both related to the relative amplitude of the vapor quality oscillations xₘₐₓ/x_{Rc}. These values define the tuning or choice of the designated volumetric traps 5 to be engaged for the particular power levels, the process which can be performed preliminary as the part of the system design.

The calculated tabulated values for the two phase specific volumes v_{t.ph} and two phase specific enthalpies h_{t.ph} for the points on the RC-line are determined with the following equations:

v_{t.ph}=vᵥₚX_{RC}+vₗ(1−X_{RC})

h_{t.ph}=hᵥₚx_{RC}+hₗ(1−x_{RC})

The data processing unit contains also the flowrate vs. pressure drop characteristics of all the expansion-needle valves 4 in the system design.

A first new aspect is the control system based on the embedded RC-line: the signal from the piping is processed through the RC-line so that the proper trap-energy generator is identified. A second new aspect is that every trap has to be tuned to the specific location on the RC-line. The tuning of the traps and assigning them to the particular power/pressure levels can be achieved by adjustment of the initial location of the piston with the provision for the max piston swept volume and should be done during the system design. When the trap exhausts its power potential, the residual condensate is drained through the drainage valve on the bottom and the cycle can be repeated.

RC-line formula for the vapor quality vs. temperature is repeated from (1):

$${x}_{RC} = \frac{d {v}_{l} / d T}{[ d {v}_{l} / d T - d {v}_{vp} / d T ]} \qquad ( 1 )$$

v₁-specific liquid volume on the saturation line, m̂3/kg

vᵥₚ-specific vapor volume on the saturation line, m̂3/kg

T-temperature, K

v_{c}-critical specific volume, m̂3/kg.

Typically steam traps are used to expel condensate from the pipe. This method would utilize the steam trap to generate additional power (residual energy) which can be stored or used to power another device.

The process takes place at first as vaporization, the quality increasing until the point where it starts to decrease. That point is unique for any two-phase volume. If the heating continues, the quality drops and the superheated liquid emerges when saturation line is crossed.

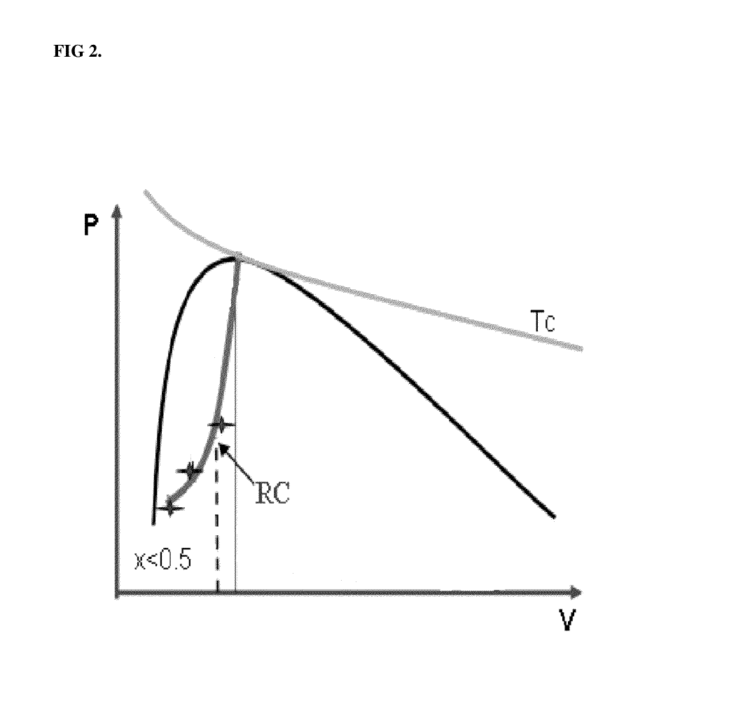

The point where quality change rate with T changes its sign (from positive to negative) is called the Retrograde Condensation point, and the locus of those Retrograde Condensation points comprise a line. FIG. 2 presents this line (locus of the Retrograde Condensation points) for water.

The phenomenon of Retrograde Condensation occurs for any fluid in the two-phase region where a reverse vapor-quality behavior takes place at a constant specific volume. For every specific volume lower than the critical, there appears a naturally occurring transition point. When under an insubstantial heat impulse, the increase in vapor changes to a decrease. From this point forth isochoric heating brings the substance to a superheated liquid state.

A Retrograde Condensation line also defines the locus of those special evaporation-condensation points for pure fluids (and exists for mixtures too). At each of these focal points, there is an evaporation-condensation cycle that oscillates with a self-sustaining frequency dependent on the properties of the fluid. Those oscillations produce pressure waves with associated amplitudes.

Oscillative Vapor/Liquid Limit Cycle Around The RC-Curve Points

$$\sqrt{\frac{x}{( 1 - x )}} ≅ sin [ ω τ + {sin}^{- 1} \sqrt{\frac{{x}_{rc}}{1 - {x}_{Rc}}} ] \\ where cycle frequency \\ ω = \frac{\overline{α} {aM}^{0.5} \sqrt{0.6 {T}_{c}}}{{( 2 π {RT}_{s} )}^{0.5}} , [ {s}^{- 1} ] \\ frequency \\ f = ω / 2 π \\ 1 < x > 0 \\ Pressure P = F ( {P}_{s} f , τ ) \\ x \text{-} quality τ \text{-} time \\ {T}_{s} \text{-} saturation temperature {P}_{s} \text{-} saturation pressure {T}_{c} \text{-} critical temperature R \text{-} universal gas const . \\ M \text{-} molecular weight α \text{-} Gibbs accomodation coefficient a \text{-} internal regression coefficient for transient pressure \text{/} volume complex vs . T \qquad ( 2 )$$

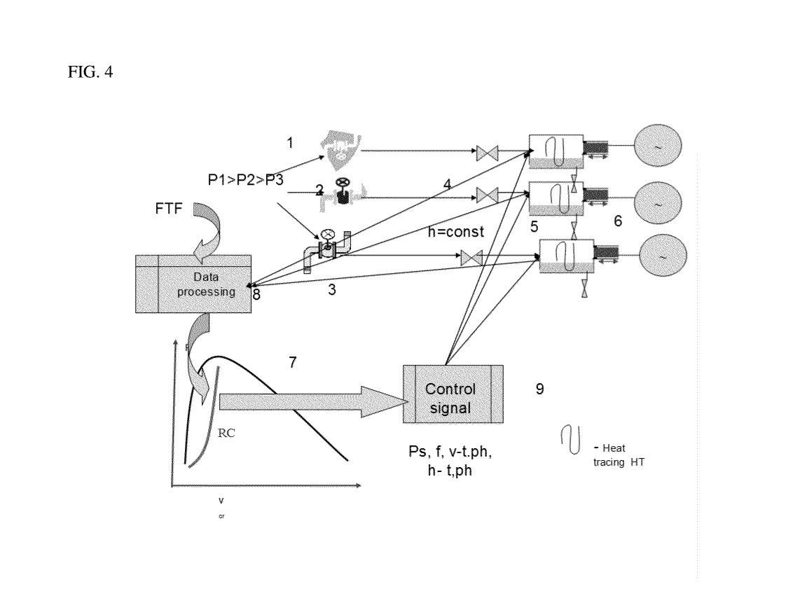

The RC based power generation cascade on the FIG. 4 can be a part of any commercial Fluid Transportation Facility (FTF) which could include supercritical fluids transportation (including cryogenic transportation), heat pumps based on supercritical gasses, particularly CO₂, high pressure water supply systems as well as high pressure condensate draining from the traps in steam power plants.

The power generation process proceeds as follows (FIG. 4):

1. At the start of the process all power generation trap volumes 5 are drained from the condensate, pistons are in the lower start positions, residual pressure sensors in 5 deliver the data to the data processing unit; the sensors on the designated high pressure pipes deliver their P, T-data to the data processing unit.

2. The data processing unit processes the data, lines up the parameters per above, designates the power-generation trap volume to use per design tuning and starts issuing the signals through the control signal system.

3. Upon receiving the signal from the data processing unit through the control signal system the heat tracing (HT) element of the designated volume 5 heats it to the Ts-level of temperature corresponding the defined point on the RC-curve. Then it turns off. Upon receiving the signal from the data processing system through the control signal system the servomotor (not shown) on the needle valve opens it and maintains the flow rate per characteristics of the valve to the designated volume 5 until the pressure and temperature feedback signals from it verify reaching the RC-point. The elapsed discharge time of the valve is defined in advance by the data processing unit through comparison of the appropriate v_{t.ph} to the final specific volume in the trap 5 designated. When time is elapsed the valve closes and the piston is released at the same moment. The oscillations begin.

4. Piston moves and power is generated per cycle (defined by the power element 6 on FIG. 4):

$$F = \frac{ω}{2 π} {\int }_{0}^{2 π / ω} P d V - Losses$$

5. The oscillation cycle proceeds until the losses component drives to the lower temperatures thus introducing a decrement and eventually halts to a full stop. The residual condensate is then drained from the volume and the piston returns to the initial position.

6. Cumulative power delivered during the functioning of the cascade (if several volumes are engaged) is either utilized for local usage or stored in flywheel type devices.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for generating power from high pressure condensate either coming from the fluid flow or expelled from a vapor trap apparatus, comprising:
providing a system of pipes either conducting the fluid flow or conducting two-phase flow, equipped with conventional vapor traps that extract and collect the high pressure condensate;
providing residual pressure sensors measuring pressure levels in the pipes conducting fluid flows or in condensate lines;
providing temperature sensors measuring temperature levels in the pipes conducting fluid flows or in the condensate lines;
providing a group of power vapor traps aligned with needle valves and moving pistons delivering power directly by condensate flash evaporation into the trap with subsequent pressure oscillations;
providing a data processing unit capable of tracking pressure and temperature data values, wherein data processing unit processes the data, lines up the parameters of piston position, pressure, temperature, and designates a trap volume to use;
providing a data processing unit capable of issuing signals through the control signal system to a needle valve and a heat tracing element;
receiving the signal from the data processing unit through the control signal system and heating the designated trap volume to a saturation temperature (Ts) corresponding to a defined point on the RC-line through a heat tracing element;
turning off the heat tracing element after the desired saturation temperature;
draining all power generation volumes of the condensate, pistons are in the lower start positions, residual pressure sensors deliver the data to the data processing unit; and
delivering pressure and temperature data provided by sensors on the high pressure pipes to the data processing unit.

2. The method as described in claim 1, where, upon receiving the signal from the data processing system through the control signal system providing a signal to the servomotor on an expansion needle valve and opening the expansion needle valve allowing flow to designated volume until the pressure and temperature feedback signals from it reach the desired RC-point.

3. The method as described in claim 2 where closing the needle valve and releasing the piston at the same moment initiates oscillations.

4. The method as described in claim 1, including the step of tuning respective vapor traps to an RC-line at different frequencies and amplitudes to create an oscillating cascade.

5. The method of claim 4 further including the tuning the trap by adjustment of the initial location of the piston.

6. The method described in claim 1, further including utilizing the power extracted for auxiliary energy storage and recharging.

7. The method described in claim 1, where after the vapor trap exhausts its power potential, further includes the step of draining the residual condensate through a drainage valve and then repeating the cycle.

8. One or more non-transitory computer readable storage media having program code stored thereon that when processed by one or more processors causes a method to be performed, the method comprising:
performing an initialization step during which information is obtained from every high pressure pipe involved in the cascade;
storing information in a first memory location of a processor;
utilizing the RC-line to calculate, based on the stored information, optimum temperature, pressure levels, and power-generation trap volume;
heating the power-generation trap volume to a saturation level corresponding to the defined point of the RC-line; and
tuning respective vapor traps to an RC-line at different frequencies and amplitudes to create an oscillating cascade.
